(19) United States
(12) Patent Application Publication
(10) Pub. No.: US 2012/0278515 A1
(43) Pub. Date: Nov. 1, 2012

(54) EXTERNAL STORAGE DEVICE AND METHOD FOR OPENING DIRECTORY PATH THEREOF

(75) Inventor: CHENG-TA HSU, Tu-Cheng (TW)

(73) Assignee: HON HAI PRECISION INDUSTRY CO., LTD., Tu-Cheng (TW)

(21) Appl. No.: 13/286,091

(22) Filed: Oct. 31, 2011

(30) Foreign Application Priority Data
Apr. 27, 2011 (TW) 100114755

(51) Int. Cl. G06F 3/00; G06F 3/033

(52) U.S. Cl. 710/48; 715/863

(57) ABSTRACT

A method opens directory paths of one or more external storage devices connected to a host computer. The method receives a selection command for opening a directory path of a selected external storage device from the selected external storage device. The method further obtains a device identifier and a directory path of the selected external storage device from a registry of an operating system (OS) of the host computer, opens the directory path of the selected external storage device, and displays all documents in the directory path on a display device of the host computer.

### BACKGROUND

1. Technical Field

Embodiments of the present disclosure relate to data access technology, and particularly to an external storage device and method for opening directory paths of external storage devices.

2. Description of Related Art

External storage devices (e.g., USB flash drives) are commonly used to store digital data between different computers. However, if more than one USB flash drives are connected to a computer simultaneously, a user must open a directory path of each USB flash disk one by one to select a document to be accessed. It is inconvenient for the user to make such a selection. Therefore, a more efficient method for opening a directory path of an external storage device is desired.

### BRIEF DESCRIPTION OF THE DRAWINGS

FIG. 1 is a block diagram of a first embodiment of an external storage device connected to a host computer.

FIG. 2 is a block diagram of a second embodiment of the external storage device connected to the host computer.

FIG. 3 is a block diagram of function modules of a driver application included in the host computer.

FIG. 4 is a flowchart of one embodiment of a method for opening a directory path of the external storage device of the FIG. 1 or FIG. 2.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

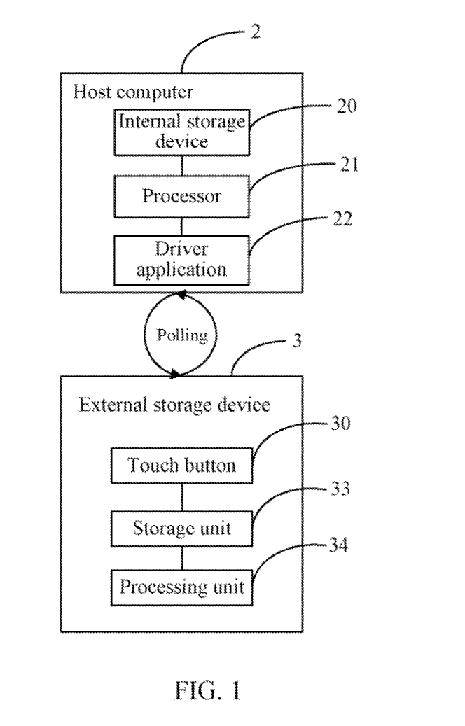

FIG. 1 is a block diagram of a first embodiment of an external storage device 3 connected to a host computer 2. The host computer 2 may include an internal storage device 20, at least one processor 21, and a driver application 22. It is well known that, the external storage device 3 also includes at least one storage unit 33 and at least one processing unit 34. The storage unit 33 may be a flash memory chip, which is used to store digital data (e.g., digital documents). The processing unit 34 may be a hardware processor used to process the digital data (e.g., editing a digital document). In the first embodiment, the external storage device 3 further includes a touch button 30 electrically connected to the at least one storage unit 33 and the at least one processing unit 34. For example, the touch button 30 is positioned on a touchable point of the external storage device 3, such as an end point of the external storage device 3. The touch button 30 is used to receive a touch signal on the external storage device 3, and sends a command for opening a directory path of the external storage device 3 to the host computer 2. In the first embodiment, the host computer 2 detects whether the touch button 30 of the external storage device 3 is pressed using a polling method. In one embodiment, the polling method refers to actively sampling the status of the external storage device 3 by a client program of the host computer 2 as a synchronous activity.

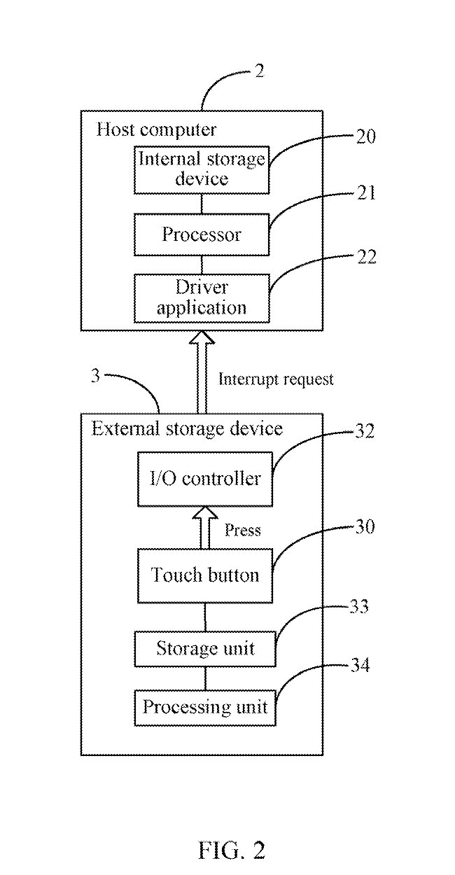

FIG. 2 is a block diagram of a second embodiment of the external storage device 3 connected to the host computer 2. As mentioned above, the external storage device 3 may include at least one storage unit 33, at least one processing unit 34, and the touch button 30. In the second embodiment, the external storage device 3 further includes an input/output (I/O) controller 32. The I/O controller 32 is electrically connected to the touch button 30, and the touch button 30 are electrically connected to the at least one storage unit 33 and the at least one processing unit 34. In the second embodiment, the I/O controller 32 is used to send the command for opening the directory path of the external storage device 3 to the host computer by sending an interrupt request to the host computer 2 if the touch signal is received by the touch button 30.

It is should be noted that the host computer 2 may connect to more than one external storage devices 3 simultaneously. Supposing that an operating system (OS) of host computer 2 is the WINDOWS system, and if one of the external storage devices 3 is selected using the touch button 30, the host computer 2 calls a function of “AddDevice( )” using a plug and play (PnP) manager of the OS, searches the driver application 22 corresponding to the selected external storage device 3, loads the driver application 22 into a memory the host computer 2, and stores a device identifier and a directory path of the selected external storage device 3 into a registry of the OS. Then, the driver application 22 starts to detects whether the touch button 30 is pressed so as to open the directory path of the selected external storage device 3. A detailed description will be given in the following paragraphs.

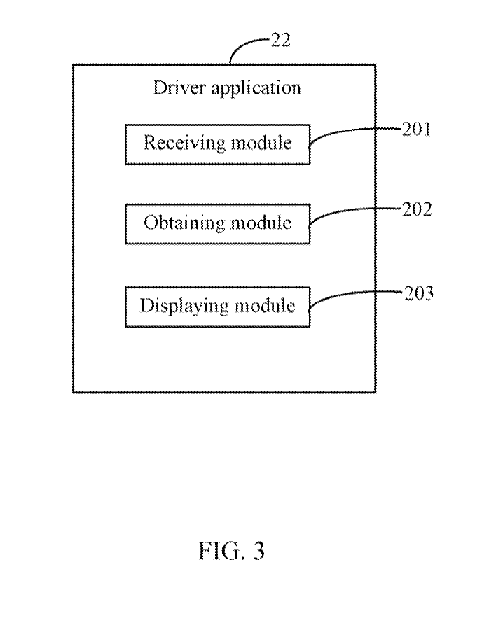

FIG. 3 is a block diagram of function modules of the driver application 22 included in the host computer 2. In one embodiment, the driver application 22 may include one or more modules, for example, a receiving module 201, a obtaining module 202, and a displaying module 203. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives. The one or more modules 201-203 may comprise computerized code in the form of one or more programs that are stored in the internal storage device 20 (or memory). The computerized code includes instructions that are executed by the at least one processor 21 to provide functions for the one or more modules 201-203.

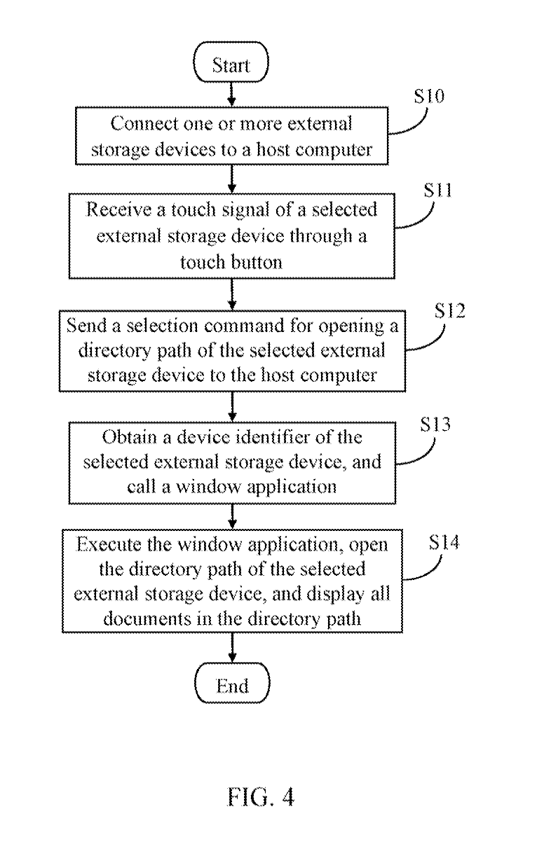

FIG. 4 is a flowchart of one embodiment of a method for opening a directory path of the external storage device 3. Depending on the embodiment, additional blocks may be added, others removed, and the ordering of the blocks may be changed.

In block S10, a user electronically connects one or more external storage devices 3 to the host computer 2.

In block S11, the user selects one of the external storage devices 3 to be accessed when he/she presses the touch button 30, the selected external storage device 3 receives a touch signal from the touch button 30 when the touch button 30 is pressed.

In block S12, the external storage device 3 generates a selection command for opening a directory path of the selected external storage device 3 according to the touch signal, and sends the selection command to the host computer 2 electronically connected to the external storage device 3 through the driver application 22, so that the driver application 22 can determine that the touch button 30 has been pressed.

If the selected external storage device 3 is the first embodiment as shown in FIG. 1, the driver application 22 detects whether a selection command is sent from one of the external storage devices 3 at a specified time interval (e.g., 1 second) using the polling method. The driver application 22 determines that the touch button 30 has been pressed when the receiving module 201 receives the selection command from the selected external storage device 3.

If the selected external storage device 3 is the second embodiment as shown in FIG. 2, the I/O controller 32 of the selected external storage device 3 sends an interrupt request to the host computer 2 when the selected external storage device 3 receives a touch signal from the touch button 30. Upon receiving the interrupt request, the receiving module 201 determines that the interrupt request as a selection command for opening a directory path of the selected external storage device 3, and determines that the touch button 30 has been pressed. In one embodiment, the interrupt request is sent from the I/O controller 32 of the selected external storage device 3 to the OS of the host computer 2 using a transmission mode of a type of human interface device (HID) class. In computing, the HID class is a part of the specification for computer peripherals, it specifies a device class (a type of computer hardware) for human interface devices such as keyboards, mice, game controllers and alphanumeric display devices.

In block S13, the obtaining module 202 obtains a device identifier of the selected external storage device 3 from the registry of an operating system (OS) of the host computer 2, selects a directory path of the selected external storage device 3 from the registry of the OS according to the device identifier of the selected external storage device 3, and calls a window application from the OS to active a file manager that is installed in the OS. In one embodiment, the window application is an application program interface (API) function pre-installed in the OS of the host computer 2. The file manager is used to manage (i.e., open or close) the directory path of the selected external storage device 3.

In block S14, the displaying module 203 executes the window application to open the directory path of the selected external storage device 3 using the file manager, and displays all documents in the directory path on a display device of the host computer 2 using a window interface. In one embodiment, the display device of the host computer 2 may be a liquid crystal display (LCD) display screen.

If more than one external storage devices 3 are connected to the host computer 2 simultaneously, the directory path of each external storage device 3 can be opened automatically by pressing the touch button 30 of the external storage device 3, then all of the documents in the directory path are displayed on the display device of host computer 2 using the window interface. That is to say, the user does not need to open the directory path of each external storage device 3 one by one to select a document to be accessed, thus much search time is reduced.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A storage device, comprising:
at least one storage unit;
at least one processing unit; and
a touch button electrically connected to the at least one storage unit and the at least one processing unit;
wherein the touch button is operable to receive a touch signal from the storage device when the touch button is pressed, generate a selection command for opening a directory path of the storage device according to the touch signal, and send the selection command to a host computer electronically connected to the storage device to open the directory path of the storage device.

2. The storage device according to claim 1, wherein the touch button is positioned on a touchable point of the storage device.

3. A storage device, comprising:
at least one storage unit;
at least one processing unit;
a touch button being electrically connected to the at least one storage unit and the at least one processing unit;
an input/output (I/O) controller being electrically connected to the touch button; wherein:
the touch button is operable to receive a touch signal from the storage device when the touch button is pressed; and
the I/O controller is operable to send a selection command for opening a directory path of the storage device to a host computer electronically connected to the storage device by sending an interrupt request to the host computer when the touch signal is received by the touch button.

4. The storage device according to claim 3, wherein the interrupt request is sent from the I/O controller of the selected external storage device to an operating system (OS) of the host computer using a transmission mode of a type of human interface device (HID) class.

5. The storage device according to claim 3, wherein the touch button is positioned on a touchable point of the storage device.

6. A computer-implemented method for opening directory paths of external storage devices, the method comprising:
electronically connecting one or more external storage devices to a host computer;
selecting an external storage device from the one or more external storage devices;
receiving a selection command for opening a directory path of the selected external storage device from the selected external storage device;
obtaining a device identifier of the selected external storage device from a registry of an operating system (OS) of the host computer, and selecting a directory path of the selected external storage device from the OS according to the device identifier;
calling a window application from the OS to active a file manager of the OS, and executing the window application to open the directory path of the selected external storage device using the file manager; and
displaying all documents in the directory path on a display device of the host computer.

7. The method according to claim 6, wherein the receiving block comprises:
detecting whether the selection command is sent from the selected external storage device using a polling method; and
receiving the selection command for opening a directory path of the selected external storage device from the selected external storage device when the selected external storage device receives a touch signal from a touch button.

8. The method according to claim 7, wherein the touch button is positioned on a touchable point of the selected external storage device.

9. The method according to claim 6, wherein the receiving block comprises:
receiving an interrupt request from an input/output (I/O) controller of a selected external storage device when the selected external storage device receives a touch signal from a touch button; and
determining that the interrupt request as the selection command for opening a directory path of the selected external storage device.

10. The method according to claim 9, wherein the interrupt request is sent from the I/O controller of the selected external storage device to the OS of the host computer using a transmission mode of a type of human interface device (HID) class.
